(19) United States
(12) Patent Application Publication
(10) Pub. No.: US 2010/0211895 A1
(43) Pub. Date: Aug. 19, 2010

(54) METHOD FOR VISUALIZATION AND INTEGRATION OF BUSINESS INTELLIGENCE DATA

(76) Inventors: Pragnesh Mistry, Gujarat (IN); Wolfgang Pfeifer, Kerzenheim (DE); Michael Rey, Speyer (DE); Carina Schneider, Mannheim (DE); Dirk Baumgaertel, Hockenheim (DE); Stefan Kraus, Bruchsal (DE); Jan Matthes, Darmstadt (DE); Anand Sinha, Bangalore (IN); Jayanth Bagare, Bangalore (IN)

Correspondence Address: SAP AG c/o BUCKLEY, MASCHOFF & TALWALKAR LLC, 50 LOCUST AVENUE, NEW CANAAN, CT, 06840, US

(21) Appl. No.: 12/371,117

(22) Filed: Feb. 13, 2009

(51) Int. Cl. G06F 3/00

(52) U.S. Cl. 715/764

(57) ABSTRACT

A method, system and means, the method includes defining a visualization dashboard, including defining at least one chart to include in the visualization dashboard and a range of data to occupy the at least one chart; defining data connections to at least one webservice of a business application platform (AP); and specifying webservice connections to a persistence of business intelligence data.

### FIELD

Some embodiments herein relate to the visualization and integration of business data. In particular, some embodiments concern integrating and implementing visualization of business related data.

### BACKGROUND

As business oriented computing systems, applications, and platforms increase in complexity, the amount of data processed by the systems, applications, and platforms, including enterprise platforms, also increases in breadth and complexity. While the accurate modeling of business transactions, interactions, and relationships between different business entities and the collection and storing of such business data may be beneficial, the presentation of the gathered and stored data may provided the added benefit of displaying the data in a configuration that is understandable by a reviewer or analyzer of the business data. In some embodiments, the user may be a business analyst, manager, or executive.

In some instances, greater insight into the operations of a business may be had or enhanced based on the use of tools and techniques that facilitate an improved understanding of the processes and relationships related to the operation of a business. Conventionally, business data has been gathered and stored in databases or data warehouses. Also, such static data has been queried and presented in tabular format. Additionally, the data is typically provided in specific and isolated tables or charts, where the data of one chart is not presented with other data.

Accordingly, a method and mechanism for efficiently defining and displaying visualizations of business data of an application platform is addressed by some embodiments herein.

### DESCRIPTION OF DRAWINGS

FIG. 1 is an exemplary block diagram of an operating environment, in accordance with various aspects of the present disclosure;

FIG. 2 a flow diagram illustrating some aspects of the present disclosure;

FIG. 3 is a example screenshot, in accordance with some embodiments herein;

FIG. 4 is a example screenshot, in accordance with some embodiments herein;

FIG. 5 is an illustrative screenshot, in accordance with some embodiments herein;

FIG. 6 is an exemplary screenshot, in accordance with some embodiments herein;

FIG. 7 is an illustrative depiction of a screenshot, in accordance with some embodiments herein; and

FIG. 8 is yet another illustrative screenshot, in accordance with some embodiments herein.

### DETAILED DESCRIPTION

In some embodiments, static business data may be transformed into or represented in dashboards and visualizations (i.e., presentations). The visualizations may include a variety of charts, including but not limited to charts and graphics that include interactive, dynamic, and animated aspects. The business data that may be represented and presented in a visualization herein may be generally referred to a business intelligence (BI) data or simply BI. That is, business intelligence may refer to the collected information related to a business entity, including, for example, information concerning the processes, knowledge, techniques, and other data associated with the operation of the business entity.

An analysis of BI may provide insight into the historical perspectives, current views, and in some instances, a predictive view of business operations to business users (e.g., manager, executives, etc.). The BI may be gathered and stored in a dedicated or general database or other data store, either locally, remotely, centralized or a combination of locations. In some embodiments, the BI data may include a business object modeled database. In general terms, a business object model defines business-related concepts for a number of business transactions. The business object (BO) model may reflect the decisions, relationships, and processes associated with real world businesses acting in business transactions and may span across different industries and business areas. The business object model is defined by business objects and their relationships to each other. Despite being applicable across different business entities and industries, business object model interfaces are consistent across the different industries and across different business units because they are generated using a single business object model.

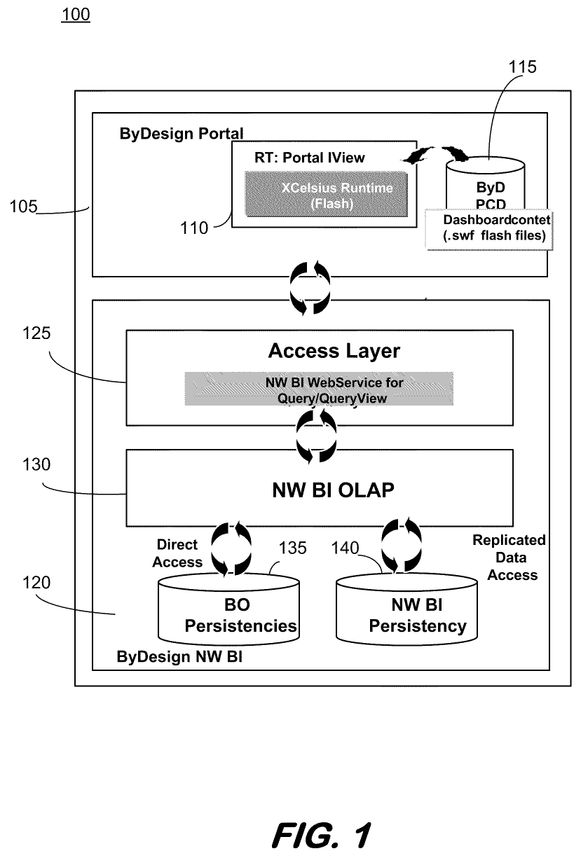

Embodiments herein provide a mechanism to integrate a visualization tool into a business application platform (AP). In some embodiments, the AP may include the Business ByDesign provided by SAP AG. FIG. 1 is a block diagram including aspects of an enterprise computing environment or system 100 suitable for implementing and supporting integration of a visualization tool into an AP that accesses BI data. System 100 may include a hosted server. System 100 includes a portal 105 (e.g., ByDesign) that provides a user interface entry point into the AP. Portal 105 includes a runtime component view (e.g., RT: Portal iView) that includes a runtime component 110 that provides the dashboard presentation or visualization of specified BI at runtime. In some embodiments, the ByDesign portal on the hosted server may be accessed by a user using an internet browser.

As illustrated, portal 105 may access dashboard content that is stored at a repository in the hosted environment of system 100. The dashboard content 115 may be formatted and stored in accordance with a protocol and/or format that sufficiently defines and encapsulates graphical presentations and representations of data. In some embodiments, dashboard content 115 may be stored and formatted as Flash files having the “.swf” file extension and distributed by Adobe®. In this manner, the files needed to configure a dashboard are embedded in the dashboard and retrieved from the hosted server. Accordingly, system 100 supports processes where data for configuring and presenting a dashboard does not need to be retrieved from an external database or other data store.

System 100 further includes data connections between portal 105 and an access layer including a webservice for implementing a service to retrieve BI data used by the dashboard. Operationally, portal 105 provides or acts as a webservices interface. In the example of FIG. 1, the ByDesign portal 105 is interfaced with an access layer 125 of Netweaver BI AP 120. Access layer 125 provides an application program interface (API) between portal 105 and the Netweaver BI AP 120. In FIG. 1, a webservice may include service for a query and/or a query view that is executed to fulfill or satisfy a request at runtime to implement a dashboard or visualization defined by a flash (or other) file embedded in the dashboard.

In some embodiments, access layer 125 may interface with a communication interface 130 that provides an interface between access layer 125 and persistencies of the BI data that will be presented in the dashboards herein. In some embodiments, communication interface 130 may include services or functionality that provides online analytical processing (OLAP).

In some embodiments, the business related data used to fulfill requests of the flash files of the dashboard may be retrieved from a persistency of BO data 135. The BO persistency may include an index of a data structure associated with an application, function, or service such as a search engine (e.g. TREX search engine). That is, a direct access to the BO data. In some other embodiments, the business related data used to fulfill requests of the flash files of the dashboard may be retrieved from a persistency of BI data 140. The BI persistency may include one or more indices of replicated BI data. The replicated BI data may include metadata that describes the BI data.

In accordance with FIG. 1, reporting content including a dashboard and dashboard configuration and implementation files (e.g., flash files) may be stored in the hosted environment of system 100. In this manner, a client of the hosted environment need not include generate, retrieve, or store such files. However, a client (not shown) in communication with portal 105 may access dashboards and visualizations related to business data of interest via a single entry point (i.e., portal).

In some embodiments, visualizations generated and presented in accordance with the present disclosure may provide a flexible process and mechanism for presenting BI data and the analysis of same. In some embodiments, visualizations may present more than one graphical chart or interactive display associated with one or more sets or collections of data. The BI data may be classified into different categories, sets, or collections based on any number of applicable parameters and/or metrics. A visualization of BI herein may include, for example, a graphical user interface presentation that includes sale data related to a business entity (e.g., product, division, sales force, time period, etc.). The visualization may, as specified by dashboard content and configuration files (e.g., flash files), multiple charts and graphic representations of the BI in a common or single graphical visualization presentation. In this manner, the dashboard content may specify including charts and graphs related to multiple sets of data in a single presentation such that a business user may efficiently compare and gain insight into the BI data.

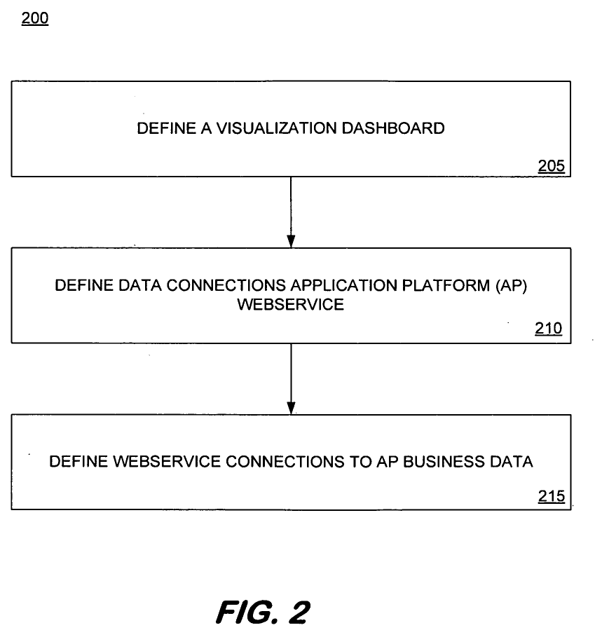

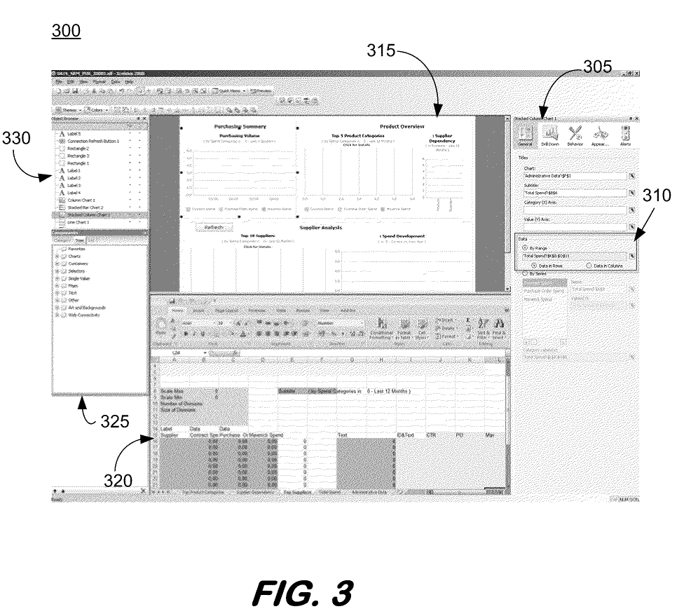

In some embodiments, a method or process is provided herein to provide, facilitate, or otherwise support integration of a visualization dashboard into a business AP. FIG. 2 provides an overview of such a process 200. At operation 205, a dashboard is defined using a user interface of a visualization service design tool. With reference to FIG. 3, there is shown an exemplary user interface 300 that may be used to define the chart(s) and data to be used in a dashboard being defined. In particular, there is shown a window 305 that includes a variety of chart templates that may be used for the dashboard. In some embodiments, a user (e.g., a developer) may specify a chart type (e.g., stacked column chart 1) and specify, for example, a title, subtitle, X axis category, Y axis value, and other defining aspects of the dashboard being defined. It is noted that additional, fewer, or other types of chart characteristics may be provided. Also, data drawn from a business data related file such as, for example, a Microsoft Office Excel® spreadsheet developed and distributed by Microsoft® may be specified at 310. The data specified at 310 may correspond to a specific range and/or values of data of the spreadsheet 320. A user may define the charts and graphs to include in the configuration of the dashboard by mapping specified charts to particular areas (i.e., ranges) in a spreadsheet (or other file), including the BI data that will deliver the content for the visualization. It is noted that windows 325 and 330 include additional aspects of the dashboard being defined that may be optionally specified by the user in configuring the dashboard. Window 315 may provide a preview of the charts and graphics being defined and comprising the dashboard.

FIG. 2 also includes a process of defining the data connections to the webservices of the AP at operation 210 such that the applicable webservices may receive the requisite input(s) to execute the webservices. This operation may include defining the input parameters of the dashboard that will deliver the requested data from the portal environment. For example, such input parameters may include the flash variables related to the language of labels, etc. and the backend URLs associated with the desired BI data.

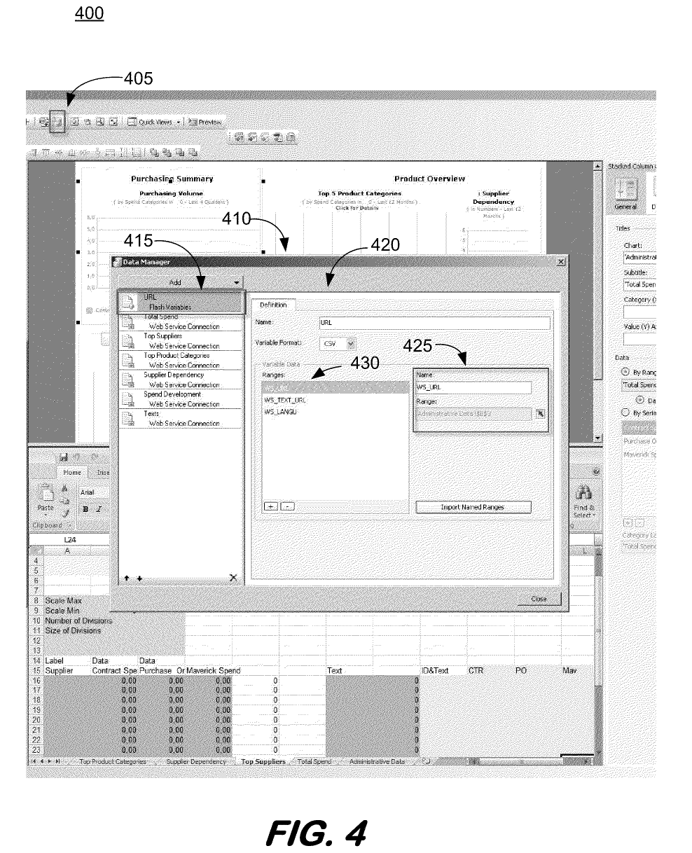

FIG. 4 includes a sample illustration of a user interface including some aspects useful is delivering operation 210. For example, a data manager icon 405 may be selected to invoke a data manger tool 410. A user may interact with data manager tool 410 to specify a URL of the flash variables of a particular webservice at 415. The URL may be particularly defined in window 420, including such characteristics as the name of the URL at 425. As illustrated, the inputs of flash variables may be mapped to specific ranges of a spreadsheet data at 430.

FIG. 2 further includes a process 215 of defining the data connections from the specified webservices to the AP backend system so that the data specified in the dashboard may be accurately and efficiently retrieved. Accordingly for example, the URL provided via the flash variable may be used to map the URL from the business data (e.g., a spreadsheet cells) to the webservice connection.

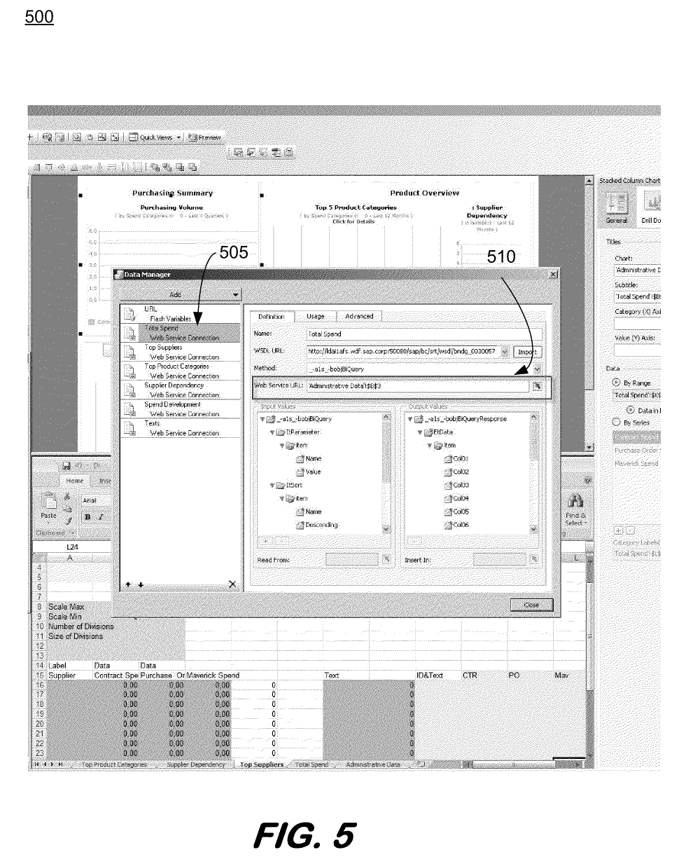

FIG. 5 includes an illustration of a user interface capturing some aspects of operation 215. For example, the web service connection “Total Spend” is added at 505 and details thereof may be specified at 510. At 510 for example, the webservice URL is specified.

Having defined configuration of a dashboard, the design time dashboard file(s) may be exported as, for example, a flash file(s). The created .swf (i.e., flash) file, as well as the design time file, may be saved in a design time repository of the hosted server from which it can be accessed.

In some embodiments, coding at the portal side may include the dashboard .swf file as an object into the portal iView and determines the values that are passed through the flash variables into the dashboard. The dashboard may be used to open connections to the backend in order to retrieve the business data.

In some embodiments, the visualizations provided in accordance with the present disclosure may provide a rendered dashboard in a preferred language of an end user. For example, in some embodiments the business data relating to a business entity is gathered and stored in the user's language as it relates to the user's business. However, the dashboards designed and generated by some of the methods herein may not be aware (at design time for example) of a particular user's language. Accordingly, language translation may be included in the visualization process so that BI data is presented in a format and manner that is easily understood by an end user. In some embodiments, a webservice may be provided to fetch data in the user's log on language from a database table in the backend. In this manner, labels of a dashboard, including for example, chart titles, legends, etc., may be retreived and presented in the user's log on language or otherwise indicated preferred language.

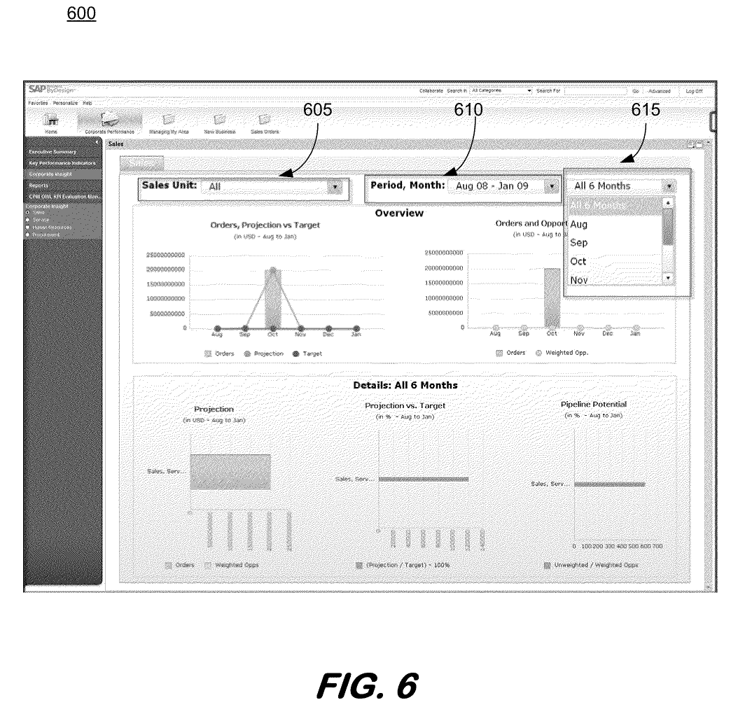

In some embodiments, a webservice may be been provided to present all possible valid values from the BI selection to the dashboards in order to allow user specified selections from the dashboard. FIG. 6 provides an illustrative example of a dashbord 600 integrated into an AP in accordance with some embodiments herein. As illustrated, the dashboard includes a graphical presentation wherein a “Sales Unit” may be specified at 605 and a time span of interest, “Period, Month”, may be specified at 610. Further illustrated at 615 is a complete listing of the possible valid values corresponding to the “Period, Month” parameter of the dashboard. In this example, a webservice may be invoked as part of providing dashboard 600 such that all possible valid values may be (optionally) provided to a user. Accordingly, a user may be assisted in providing valid choices in reply to a prompt for a value, without a need to necessarily have knowledge of all of the possible values.

It is noted that from an architecture perspective, the integration of the F4-help values into the dashboard can include storing the flash associated with the dashboard file in the design time repository of the server. Upon opening a view (e.g., iView) of a dashboard, the flash file is loaded from the design time repository and the determined values for URL, language, etc. are passed to the flash file. The flash file may then open the necessary connections to the backend in order to retrieve the business data. In some embodiments, one webservice may provide translated labels; another webservice may provide F4-help values, if needed; and one webservice may retrieve the BI Data. The webservice that retreives the BI data, in some embodiments, may be a wrapper service for the Netweaver BI service as the result set of the NW BI Service has a structure that is flattened in this wrapper service. The wrapper service can call the NW BI Service and may also fetch data from the BO persistency and format the for the dashboard visualization. In this manner, the formated data is passed back to the flash file. The flash file may further indicate that the data that has been received via the connection.

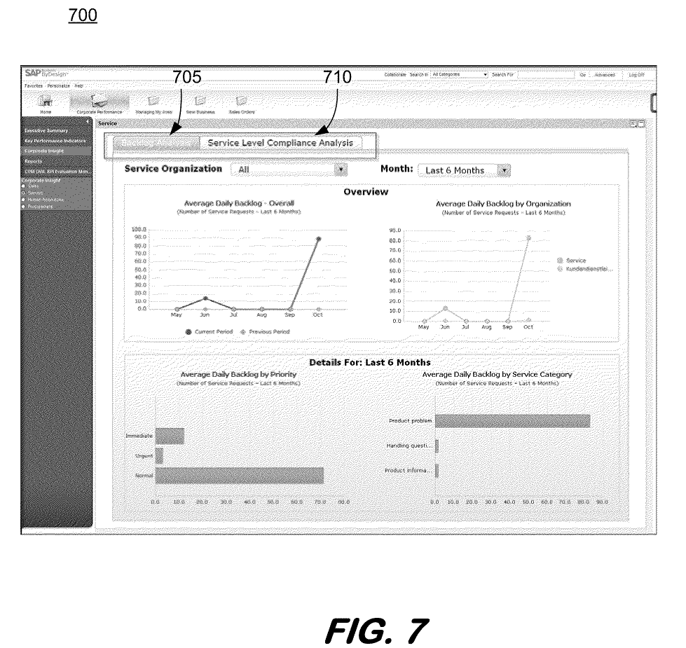

In some embodiments, the present disclosure provides a system and method for providing visualisations of BI Content. In accordance with some embodiments, business data may be configured and presented in a side-by-side configuration on one screen such that trends or comparisons can be readily seen by the display of multiple charts. In some embodiments, a dashboard herein may include several tabs as shown in FIG. 7. As illustrated therein, dashboard 700 includes a “Backlog Analysis” tab and a “Service Level Compliance Analysis” tab 710. Each of the tabs may be selected to quickly access and display specified categories of business data.

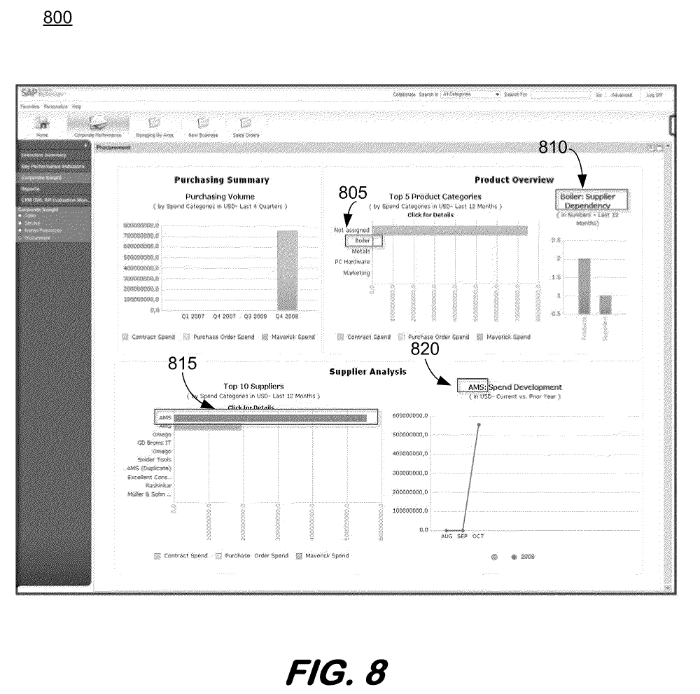

In some embodiments, at least some drill-down functionality may be provided in a dashboard such that, for example, a user can select a parameter and have additional detailed information presented, as shown in FIG. 8. For example, a supplier may be selected in one chart 815 of dashboard 800 and detailed information 820 regarding the selected supplier may be provide in another or all other charts. Dashboard 800 also illustrates selection of a product 805 and provides detailed information regarding the selected product at chart 810

In particular, a method is disclosed for providing an enhanced visualization or display of business data. The business data may be stored in one or more databases. In some embodiments, the visualizations provided may include multiple charts and graphical representations of business intelligence (BI) data on a single, common graphical user interface. In this manner, analysis of the BI data may be improved as compared to a review of the BI data in a conventional tabular format where each set of data is presented in its own table.

In some embodiments, the visualizations defined and generated by the method herein may be used by one or more applications. In this manner repeated business analytics may be made more efficient.

In some embodiments, the visualizations defined and generated by the method herein may be used by one or more applications. In this manner repeated business analytics may be made more efficient.

The embodiments herein may be implemented in computer hardware, firmware, software, or in combinations of them. Some embodiments may be implemented as a computer program product, i.e., a computer program tangibly embodied in a hardware medium, e.g., in a machine-readable storage device having program code or instructions stored thereof, for execution by, or to control the operation of, a data processor (e.g., a programmable processor, a computer, or network of computers). In some embodiments, a computer program in accordance with the present disclosure may be implemented independent of a particular programming language and/or processing system and/or computer operation or application platform.

Suitable processors for the execution of a program of instructions include, by way of example, both general and special purpose microprocessors, and the sole processor or one of multiple processors of any kind of computer. Storage devices and mediums suitable for tangibly embodying computer program instructions and data may include, for example, all forms of non-volatile memory, magnetic disks, magneto-optical disks, CD-ROM and DVD-ROM disks. In related embodiments, computer program may operate independent of any particular form of programming language, computing system, industry, application, communication protocol, and operating system.

A number of embodiments of the invention have been described herein. However, it will be understood that various modifications may be made without departing from the spirit and scope of the invention. Accordingly, other implementations are within the scope of the following claims.

What is claimed is:

1. A computer implemented method, the method comprising:
defining, by a computer, a visualization dashboard, including defining at least one chart to include in the visualization dashboard and a range of data to occupy the at least one chart;
defining data connections to at least one webservice of a business application platform (AP); and
specifying webservice connections to a persistence of business intelligence data.

2. The method of claim 1, wherein the defining of the visualization dashboard further comprises mapping the at least one chart to a range of data in a spreadsheet associated with the business intelligence data.

3. The method of claim 1, further comprising specifying input variables of the dashboard.

4. The method of claim 1, wherein the dashboard is defined to include multiple charts in a common presentation display of the dashboard.

5. The method of claim 1, wherein the defined dashboard includes an embedded runtime flash file.

6. The method of claim 1, wherein a webservice is specified to provide a language translation function for labels associated with the dashboard.

7. A computer implemented method, the method comprising:
storing a user defined runtime file defining a visualization dashboard in a repository of a hosted server;
invoking, by a computer, an execution of the runtime file via a portal view, the runtime file being loaded from the repository of a hosted server;
opening data connections to an access layer of a business application platform (AP) to retrieve business intelligence (BI) data from one or more persistencies of the BI data; and
retrieving BI data to populate the dashboard using a webservice to obtain translated chart labels and a webservice to retrieve the BI data.

8. The method of claim 7, wherein the runtime file is a Adobe Flash formatted file.

9. The method of claim 7, further comprising a webservice to obtain all possible valid values.

10. The method of 7, wherein the dashboard is defined to include a plurality of tabs, each tab controlling a display of multiple charts in a single user interface display.

11. The method of 7, further comprising displaying the dashboard on a display device multiple charts in a single user interface display.

12. The method of 11, further comprising rendering the dashboard is a preferred language and displaying the dashboard in the preferred language.

13. The method of 12, wherein a webservice provides a language translation associated with the rendering of the dashboard in the preferred language.
